(19) United States
(12) Patent Application Publication
(10) Pub. No.: US 2017/0142389 A1
(43) Pub. Date: May 18, 2017

(54) METHOD AND DEVICE FOR DISPLAYING PANORAMIC VIDEOS

(71) Applicants: Le Holdings (Beijing) Co., Ltd., Beijing (CN); Le Shi Internet Information Technology Corp. Beiji, Beijing (CN)

(72) Inventors: Kexin YANG, Beijing (CN); Lindu WANG, Beijing (CN)

(21) Appl. No.: 15/240,722

(22) Filed: Aug. 18, 2016

Related U.S. Application Data
(63) Continuation of application No. PCT/CN2016/083150, filed on May 24, 2016.

(30) Foreign Application Priority Data
Nov. 18, 2015 (CN) 201510794513.9
May 24, 2016 (CN) PCT/CN2016/083150

(51) Int. Cl. H04N 13/00; G06T 3/00; G06T 3/40; H04N 13/04

(52) U.S. Cl. CPC H04N 13/0014; H04N 13/0445; G06T 3/0018; G06T 3/4038

(57) ABSTRACT

The present application discloses a method and a device for displaying panoramic videos. The method includes: loading a panoramic video from a server through an Html5 video tag in a play page; mapping the panoramic video to the inner surface of a sphere model in a scene as a texture image of the sphere model, wherein the scene is created by an 3D engine, and further includes a camera object disposed inside the sphere model; and displaying a video image of the inner surface of the sphere model shot by the camera object under the current viewing angle in the play page. A third-party plug-in is not needed to be installed while viewing the panoramic video in the web page through a browser, so that the panoramic video can be applied in the internet video more widely, thus providing expedience for an internet user to view the panoramic video.

### CROSS-REFERENCE

This application is a continuation of International Application No. PCT/CN2016/083150, filed May 24, 2016, which is based upon and claims priority to Chinese Patent Application 201510794513.9, filed Nov. 18, 2015, the entire contents of all of which are incorporated herein by reference.

### TECHNICAL FIELD

The present disclosure belongs to the field of internet, and more particularly, relates to a method and a device for displaying panoramic videos.

### BACKGROUND

When playing a conventional network video, the visible area of the video contents are fixed and not adjustable due to the shooting (for example: the viewing angle and range of a camera lens), i.e., a user can view the current area only, and a video frame changes with the moving of the camera lens, so that the user lacks a scene feeling while viewing, and cannot be immersive.

The appearance of panoramic videos in recent years brings a fire-new visual experience to the network video users, and the panoramic video refers to a video having a 360-degree viewing angle. The panoramic video has better spatial and realistic effects, and can provide visual experience preferably. A Flash 360-degree panoramic player written through ActionScript has appeared presently, which may implement the panoramic video play of a web page. However, because the player is based on the features of Flash animation, the player cannot be used in a browser which does not support Flash or is not installed with a Flash plug-in, which causes limitations to the user to view panoramic network videos.

### SUMMARY

In light of this, the embodiments of the present disclosure provide a method and a device for displaying panoramic videos, for solving the technical problem in the prior art that the user cannot view panoramic videos in a browser that does not support Flash or is not installed with a Flash plug-in.

In order to solve the foregoing technical problem, the embodiments of the present disclosure disclose a method for displaying panoramic videos, including: loading a panoramic video from a server through an Html5 video tag in a play page; mapping the panoramic video to the inner surface of a sphere model in a scene as a texture image of the sphere model, wherein the scene is created by an 3D engine, and further includes a camera object disposed inside the sphere model; and displaying a video image of the inner surface of the sphere model shot by the camera object under the current viewing angle in the play page.

In order to solve the foregoing technical problem, the present disclosure also discloses a device for displaying panoramic videos, including: a video loading module configured to load a panoramic video from a server through an Html5 video tag in a play page; an image mapping module configured to map the panoramic video to the inner surface of a sphere model in a scene as a texture image of the sphere model, wherein the scene is created by an 3D engine, and further includes a camera object disposed inside the sphere model; and a video display module configured to display a video image of the inner surface of the sphere model shot by the camera object under the current viewing angle in the play page.

In order to solve the foregoing technical problem, the present disclosure also discloses a device for displaying panoramic videos, including: a processor; and a memory for storing instructions executable by the processor; wherein the processor is configured to: load a panoramic video from a server through an Html5 video tag in a play page; map the panoramic video to the inner surface of a sphere model in a scene as a texture image of the sphere model, wherein the scene is created by an 3D engine, and further includes a camera object disposed inside the sphere model; and display a video image of the inner surface of the sphere model shot by the camera object under the current viewing angle in the play page.

Compared with the prior art, the method and device for displaying panoramic videos provided by the embodiments of the present disclosure load the panoramic video from the server through the Html5 video tag, and use the 3D engine of the browser to complete playing, are no longer limited to a Flash animation manner and do not need to install a third-party plug-in while viewing the panoramic video in the web page through the browser, so that the panoramic video can be applied in the internet video more widely, thus providing expedience for the internet users to view the panoramic videos.

### BRIEF DESCRIPTION OF THE DRAWINGS

In order to explain the technical solutions in the embodiments of the disclosure or in the prior art more clearly, the drawings used in the descriptions of the embodiments or the prior art will be simply introduced hereinafter. It is apparent that the drawings described hereinafter are merely some embodiments of the disclosure, and those skilled in the art may also obtain other drawings according to these drawings without going through creative work.

FIG. 1 is a flow chart of a method for displaying panoramic videos provided by the embodiments of the present disclosure;

FIG. 2 is a flow chart of the method for displaying panoramic videos provided by the embodiments of the present disclosure;

FIG. 3 is a flow chart of the method for displaying panoramic videos provided by the embodiment of the present disclosure;

FIG. 4 is a block diagram of a device for displaying panoramic videos provided by the embodiment of the present disclosure; and

FIG. 5 is a block diagram of the device for displaying panoramic videos provided by the embodiment of the present disclosure.

### DETAILED DESCRIPTION

To make the objects, technical solutions and advantages of the embodiments of the present disclosure more clearly, the technical solutions of the present disclosure will be clearly and completely described hereinafter with reference to the embodiments and drawings of the present disclosure. Apparently, the embodiments described are merely partial embodiments of the present disclosure, rather than all embodiments. Other embodiments derived by those having ordinary skills in the art on the basis of the embodiments of the present disclosure without going through creative efforts shall all fall within the protection scope of the present disclosure.

According to the embodiments of the present disclosure, in a network video play page opened by a browser of a terminal device, a panoramic video shot by a panoramic camera is loaded from a server through a Html5 (HTML5 is the core language of World-Wide-Web, which is the fifth significant modification of an application hypertext markup language under standard generalized markup language) video tag, and a 3D scene is created by a 3D engine, wherein the scene includes a sphere and a camera object inside the sphere to map the panoramic video to the inner surface of the sphere as a texture image of the sphere. When the panoramic video is played in the browser, a video image shot by the camera object under the current viewing angle is displayed in the play page. A third-party plug-in is not needed to be installed while viewing the panoramic video in the webpage through a browser, so that the panoramic video can be applied in the internet video more widely, thus providing expedience for an internet user to view the panoramic video.

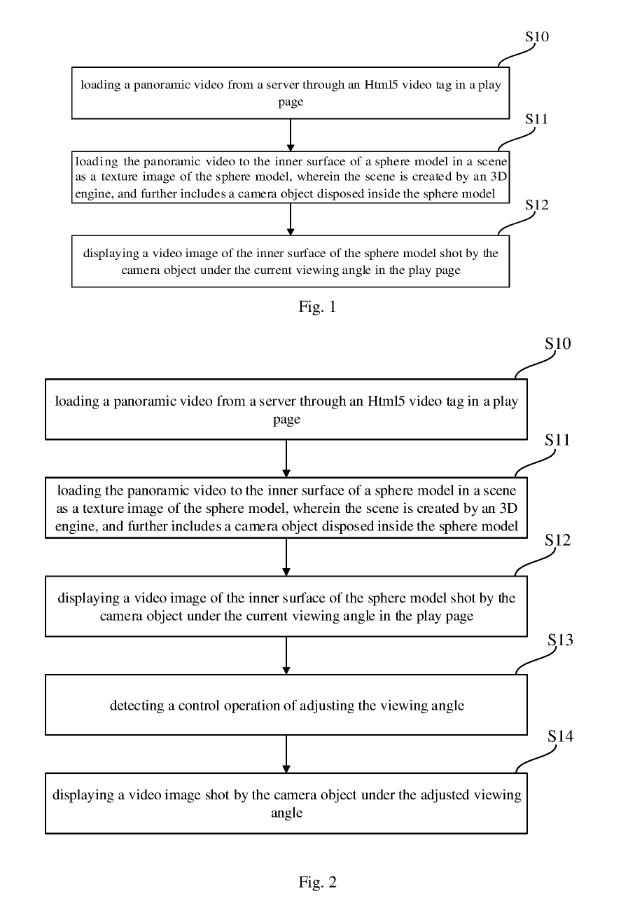

FIG. 1 is a method for displaying panoramic videos provided by the embodiment of the present disclosure, which is applied to a terminal device, wherein the terminal device can be a mobile phone, a computer, a smart TV, a digital broadcast terminal, a messaging device, a gaming console, an on-vehicle console, a tablet device, a medical device, an exercise equipment, a personal digital assistant, or the like. As shown in FIG. 1, the method includes the following steps S10-S12.

In step S10, a panoramic video is loaded from a server through an Html5 video tag in a play page.

The video tag is a new element defined by HTML5 and used for designating a standard manner to insert a video file into a web page without needing to install any third-party software at the browser, for example, without needing to install a third-party plug-in based on Flash: Adobe Flash Player.

The Video tag includes a source (referred to as scr) attribute, and the value of the attribute is the URL address of the panoramic video loaded in the page, for example:

<video id=“media” src=“http://www.123456.com/test.mp4” controls width=“400px” heigt=“400px”></video>.

Wherein, src=http://www.123456.com/test.mp4 represents the URL address of a server where the panoramic video locates. The appearance of an attribute “control” represents to display a video control in the page, for instance, a play button, a progress bar, or the like. “width” represents the width of a video player in the page, and “heigt” represents the height of the video player in the page.

Moreover, the video tag at least may also include the following attribute information.

The appearance of an attribute “autoplay” represents that the video will be played immediately after the video is completely loaded in the page.

The appearance of an attribute “loop” represents that it starts to play again after the video file is completely played.

An attribute “preload” represents that the video is loaded and ready for playing during the loading of the page; if the attribute “autoplay” appears at the same time, then the attribute “preload” will be ignored.

According to the foregoing attributes defined in the video tag, the browser loads the video player in the page and loads the panoramic video from the server according to the URL address of the scr attribute.

The format of the panoramic video may either be an Ogg format, an MPEG4 format or a WebM format. Wherein, the Ogg format is an Ogg file with a Thedora video code and a Vorbis audio code; the MPEG4 format is an MPEG 4 file with a H.264 video code and an AAC audio code; and the WebM format is a WebM file with VP8 video code and a Vorbis audio code. Or, the panoramic video is transcoded into the foregoing three formats respectively at the server so as to adapt to different browsers, determine a browser used by a terminal device according to a user agent string in a request message from the terminal device, and send the video format that can be played by the browser to the terminal device.

In step S11, the panoramic video is mapped to the inner surface of a sphere model in a scene as a texture image of the sphere model, wherein the scene is created by an 3D engine, and further includes a camera object disposed inside the sphere model.

A 3D scene is created through a 3D engine running in the browser, for example, a 3D engine three.j s. Wherein, three.j s is a WebGL third-party library written by JavaScript, and is a 3D engine running in the browser.

The 3D scene and the camera object used in the 3D scene may be created using the scene and perspective camera (PerspectiveCamera) of three.js, for example:

this.scene=new THREE.Scene( )

this.camera=new THREE.PerspectiveCamera(75, cw/ch, 0.1, 1000).

Wherein, the construction function of the perspective camera is shown as follows:

Four parameters set for the PerspectiveCamera (fov, aspect, near, far) are field of view (fov), aspect ratio (aspect), near plane (near) and far plane (far) respectively. Wherein, the field of view refers to the visual angle of the camera object, which may be understood as being similar to the opening angle of eyes. The larger the eyes open, the wider the range of visibility is. Therefore, the larger the value of the field of view is, the wider the frame shot by the camera object is, and accordingly, the image of an object in the center of the frame is smaller. The aspect ratio represents the aspect ratio of the frame shot by the camera object, i.e., the width divided by the height, wherein the larger the value is, the larger the width of the frame is. The near plane represents the nearest distance that can be shot by the camera object, while the far plane represents the farthest distance that can be shot by the camera object. In the above example, the field of view of the camera object is 75 degrees, the aspect ratio is cw(camerawidth/ch (cameraheigt), the near plane is 0.1, and the far plane is 1000.

After the scene and the camera object are completely created, a renderer also needs to be created in order to render the scene shot by the camera object. Two renderers normally used by three.js are WebGLRenderer and CanvasRenderer, wherein using WebGLRenderer can acquire a preferable visual effect, and the requirement on the hardware condition of the terminal device is higher; otherwise, the terminal device cannot support WebGLRenderer, while adopting CanvasRenderer can support more terminal devices, and the compatibility of CanvasRenderer is higher. For example, codes for creating WebGLRenderer and adding a Canvas tag into the element in the page are as follows:

this.renderer=window.WebGLRenderingContext?new THREE.WebGLRenderer( ): new THREE.CanvasRenderer( )

this.renderer.setSize(cw, ch);

this.canvas=vjs(this.renderer.domElement);

this.playerCon[0].appendChild(this.canvas[0]).

Then, an image of the video tag is set as the texture image of the inner surface of the sphere model. Firstly, a texture object is created, for example, the Texture of three.js is used to create a texture object, and the video tag is transferred to the texture object as a rendered image, wherein implementing codes are as follows:

this.textureReflection=newTHREE.Texture(this.video, THREE. SphericalReflectio nMapping).

THREE.Texture is a texture construction function, wherein the standard format thereof is:

THREE.Texture=function (image, mapping, wrapS, wrapT, magFilter, minFilter, format, type, anisotropy); wherein, the first parameter image is configured to receive an image in an image type or a video tag, and a parameter mapping represents a mapping mode, wherein the THREE.SphericalReflectionMapping in the above example represents a mapping manner reflected by a 3D sphere. If the other parameters are not set, then the THREE.Texture construction function will be stuffed automatically by default values.

Then, a material object is created, and the texture image is transferred to the material object. For example, the texture may be transferred to THREE.MeshBasicMaterial through the following codes:

var material=new THREE.MeshBasicMaterial({

map: this.textureReflection,

side: THREE.BackSide

}).

Then, a sphere model is created in the scene and coordinates of the sphere model are set in the scene. Firstly, a sphere is created, for example:

var geometry=new THREE. SphereGeometry(80,64,64);

THREE.SphereGeometry is a construction function of the sphere, and a standard format thereof is THREE.SphereGeometry (radius, segmentsWidth, segmentsHeight, phiStart, phiLength, thetaStart, thetaLength). Wherein, radius is radius; segmentsWidth represents the number of segments on longitude; segmentsHeight represents the number of segments on latitude; phiStart represents starting radian of longitude; phiLength represents radian crossed by longitude; thetaStart represents starting radian of latitude; thetaLength represents radian crossed by latitude. In the above example, the sphere radius of the construction is 80, both the number of segments on longitude and the number of segments on latitude are 64.

Then, a corresponding model is created for the above sphere, coordinates of the sphere model in the scene is set, and the sphere model is added into the scene. For example, the process may be implemented through the following codes:

var sphere=new THREE.Mesh(geometry, material);

sphere.position.x=0;

sphere.position.y=0;

sphere.position.z=0;

sphere.rotation.x=Math.PI;

this.scene.add(sphere).

The model is composed of faces, wherein the faces include a triangle face and a quadrilateral face, and the triangle face and the quadrilateral face form a mesh model. THREE.Mesh is used to represent the mesh model in Three.js.

A THREE.Mesh construction function is:

THREE.Mesh=function (geometry, material); wherein, the first parameter geometry is an object in a THREE.Geometry type, which is an object including a connecting relationship between top points. The second parameter Material is a material defined, wherein the material will affect the action effects of illumination and textures on the mesh.

In the created scene, the camera object is disposed inside the sphere model, so that the camera object can shoot the texture image of the inner surface of the sphere, i.e., the panoramic image loaded through the video tag.

In step S12, a video image of the inner surface of the spherical model shot by the camera object under the current viewing angle is displayed in the play page.

When the loaded panoramic video starts being played automatically or is triggered to play through a control by the user, the video image of the inner surface of the sphere model shot by the camera object is rendered. In Three.js, the loaded panoramic image may be rendered frame-by-frame. Using, two functions like setTimeout or setlnterval, or a cascading stylesheet (css) 3 may be used for implementation. However, css3 animation has some limitations, for instance, not all the attributes can participate in the animation, the slow acting effects of the animation are few, the animation process cannot be completely controlled, or the like, while setTimeout and setInterval have severe efficiency problems. Therefore, a requestAnimationFrame function is used to render frame-by-frame, and the advantages thereof include: A. requestAnimationFrame will concentrate all the document object model (DOM) operations in each frame together, and complete all the operations in redrawing or refluxing at a time; moreover, the time interval for redrawing or refluxing tightly follows the refresh rate of the browser; and generally, the frequency is 60 s/frame; and B. in hidden or invisible elements, requestAnimationFrame will not perform redrawing or refluxing, which certainly means less CPU, GPU and memory usage.

For example, a requestAnimationFrame function is used to render frame-by-frame; meanwhile, the needsUpdate attribute of the texture object is set as true, and the corresponding codes are as follows:

this.renderer.render(this.scene, this.camera);

requestAnimationFrame(this.animate);

this.textureReflection.needsUpdate=true.

A NeedsUpdate attribute is configured to notify the renderer that this frame needs to update and cache. For the video texture, because the video is a picture stream, and the frames to be displayed by each frame are different; therefore, needsUpdate shall be set as true for each frame so as to update the texture data cached in a display card.

In the embodiment, the panoramic video is loaded from the server through the Html5 video tag, and the 3D engine of the browser is used to complete playing; moreover, a third-party plug-in is not needed to be installed while viewing the panoramic video in the webpage through the browser, so that the panoramic video can be applied in the internet video more widely, thus providing expedience for the internet users to view the panoramic videos.

In one embodiment, as shown in FIG. 2, the method for displaying panoramic videos further includes the following steps S13-S14.

In step S13, a control operation of adjusting the viewing angle is detected.

In step S14, a video image shot by the camera object under the adjusted viewing angle is displayed.

The panoramic video is mapped to the inner surface of the sphere model. In order to enable the user to view the 360-degree panoramic video through a browser page, it is desirable to allow the user to adjust the viewing angle of the camera object in the scene through a control operation, so as to view the panoramic video from various angles, wherein the control operation may be an operation from a mouse or gesture.

The control operation of the user for adjusting the viewing angle will trigger a corresponding system event, for example, clicking and moving events of the mouse. The control operation of the user for adjusting the viewing angle is detected through monitoring a corresponding system event. For example, a lookAt method of the camera object in Three.js is invoked to adjust the viewing angle, and then the video image under the adjusted viewing angle is rendered, wherein the corresponding implementing codes are as follows:

this.cameraTarget.x=1*Math.sin(phi)*Math.cos(theta);

this.cameraTarget.y=1*Math.cos(phi);

this.cameraTarget.z=1*Math.sin(phi)*Math.sin(theta);

this.camera.position.copy(this.cameraTarget).negate( )

this.camera.lookAt(this.cameraTarget).

In the embodiment, after the panoramic video is displayed in the browser page, the user may adjust the viewing direction and angle of the panoramic video in anytime through the mouse or gesture operation, so that the user can view the frames of the panoramic video from each angle in all directions.

In one embodiment, a cross-origin problem will exist between the panoramic video and the play page. The cross-origin problem refers to that a js script under an a.com origin name cannot operate an object under a b.com or c.a.com origin name due to the limitation of the same-origin policy of JavaScript, and data communication is not even allowed on different ports, different protocols or different sub-origins under the same origin name If the above cross-origin problem exists between the URL address loaded with the panoramic video and the URL address of the page visited by the browser, as shown in FIG. 3, step S10 is further implemented as the following steps S101-S102.

In step S101, the panoramic video is requested from the server, the cross-origin (crossOrigin) attribute of the video tag being set as anonymous.

The CrossOrigin attribute is used for setting cross-origin resource sharing (CORS). When the cross-origin attribute is set as anonymous, it represents that cross-origin resource sharing is allowed.

In step S102, the panoramic video returned by the server is received, wherein an http response header of the panoramic video includes declaration information.

If it is desirable to implement cross-Origin resource sharing, the server saving the panoramic video also needs to declare which origins are allowed to implement cross-origin resource share therewith, and record the origin information allowing cross-origin resource share in the declaration information, for example, Access-Control-Allow-Origin.

The http response header returned by the server includes the declaration information. The declaration information may be a list. If the received declaration information includes the origin information of the origin where the pay page locates, then the data of the panoramic video can be acquired from the server. In some cases, the declaration information of the http response header returned by the server is set as a wildcard “*,” for example, Access-Control-Allow-Origin:*, then it represents allowing cross-origin resource request from any origin.

In the embodiment, cross-origin resource sharing with respect to the resources of the panoramic video is implemented, so that more websites and platforms can request to play the panoramic video, thus increasing the audience of the panoramic video business, enabling more network users to experience the business, and enabling the server of the panoramic video business to provide more plentiful contents to the user in the meanwhile.

In one embodiment, the viewing angle of the camera object in the scene may be set as fish-eye lens, wherein the range of the fish-eye lens viewing angle is larger, and is suitable for shooting large-scale scenery and scenario in the near distance. In the embodiment, the fish-eye lens viewing angle ranges from 180 degrees to 220 degrees. The fish-eye lens can cause a very strong perspective effect when shooting close to a subject to be shot, so that the frame shot has striking infection. The panoramic image of the inside surface of the sphere model shot through the fish-eye lens has a wider image shooting range, and enhances the visual impact force of the image.

The method for displaying panoramic videos provided by the embodiment of the present disclosure is more suitable for a live scene of network videos, for example, when on-scene live broadcast is performed on a conference, a social, a vocal concert, a large ceremony, the on-scene frame is shot through the panoramic pick-up device; after the on-scene frame is loaded to a live webcast page, the user may view the on-scene video image under a default viewing angle and may adjust the viewing angle through mouse or gesture operation so as to view the on-scene frame from other viewing angles. The user can view the on-scene frame by 360 degrees and experience a vivid on-scene effect.

Embodiments of devices of the present disclosure are described hereinafter, which may be used for performing the foregoing method according to the embodiments of the present disclosure.

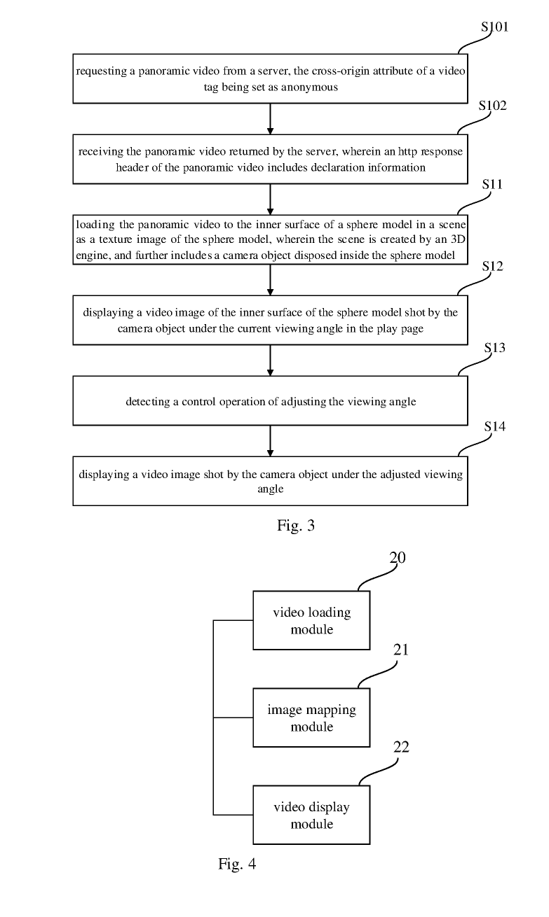

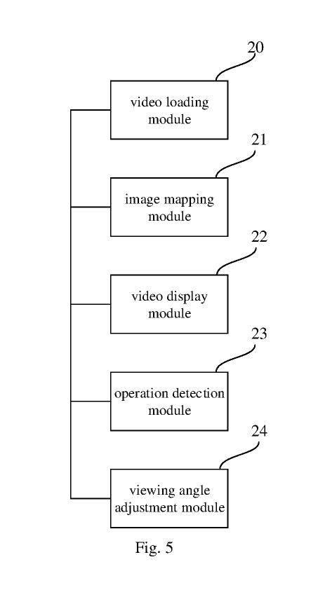

FIG. 4 is a block diagram of a device for displaying panoramic videos provided by the embodiment of the present disclosure, including:

a video loading module 20 configured to load a panoramic video from a server through an Html5 video tag in a play page;

an image mapping module 21 configured to map the panoramic video to the inner surface of a sphere model in a scene as a texture image of the sphere model, wherein the scene is created by an 3D engine, and further includes a camera object disposed inside the sphere model; and

a video display module 22 configured to display a video image of the inner surface of the sphere model shot by the camera object under the current viewing angle in the play page.

In one embodiment, as shown in FIG. 5, the device further includes:

an operation detection module 23 configured to detect a control operation of adjusting the viewing angle; and

a viewing angle adjustment module 24 configured to display a video image shot by the camera object under the adjusted viewing angle.

In one embodiment, the video loading module 20 further includes:

a request submodule configured to request the panoramic video from the server, the cross-origin (crossOrigin) attribute of the video tag being set as anonymous; and

a receiving submodule receiving submodule configured to receive the panoramic video returned by the server, wherein an http response header of the panoramic video declaration information.

Furthermore, each functional module above in the embodiments of the present disclosure can be implemented through a hardware processor.

The embodiment of the present disclosure provides a device for displaying panoramic videos, including:

a processor; and

a memory for storing instructions executable by the processor; vwherein the processor is configured to:

load a panoramic video from a server through an Html5 video tag in a play page;

map the panoramic video to the inner surface of a sphere model in a scene as a texture image of the sphere model, wherein the scene is created by an 3D engine, and further includes a camera object disposed inside the sphere model; and

display a video image of the inner surface of the sphere model shot by the camera object under the current viewing angle in the play page.

In one embodiment, the processor is further configured to:

detect a control operation of adjusting the viewing angle; and

display a video image shot by the camera object under the adjusted viewing angle.

When a cross-origin problem exists between the panoramic video and the play page, the loading the panoramic video from the server through the Html5 video tag in the play page includes:

requesting the panoramic video from the server, the cross-origin (crossOrigin) attribute of the video tag being set as anonymous; and

receiving the panoramic video returned by the server, wherein an http response header of the panoramic video comprises declaration information.

The declaration information includes the origin information of the play page, or the declaration information is a wildcard that represents to allow requesting data from any origin.

The viewing angle of the camera object is set as a fish-eye lens viewing angle.

The fish-eye lens viewing angle ranges from 180 degrees to 220 degrees.

The panoramic video is a live video shot by a panoramic pick-up device.

The device embodiments described above are only exemplary, wherein the units illustrated as separation parts may either be or not physically separated, and the parts displayed by units may either be or not physical units, i.e., the parts may either be located in the same plate, or be distributed on a plurality of network units. A part or all of the modules may be selected according to an actual requirement to achieve the objectives of the solutions in the embodiments. Those having ordinary skills in the art may understand and implement without going through creative work.

Through the above description of the implementation manners, those skilled in the art may clearly understand that each implementation manner may be achieved in a manner of combining software and a necessary common hardware platform, and certainly may also be achieved by hardware. Based on such understanding, the foregoing technical solutions essentially, or the part contributing to the prior art may be implemented in the form of a software product. The computer software product may be stored in a storage medium such as a ROM/RAM, a diskette, an optical disk or the like, and includes several instructions for instructing a computer device (which may be a personal computer, a server, or a network device so on) to execute the method according to each embodiment or some parts of the embodiments.

It should be finally noted that the above embodiments are only configured to explain the technical solutions of the present disclosure, but are not intended to limit the present disclosure. Although the present disclosure has been illustrated in detail according to the foregoing embodiments, those having ordinary skills in the art should understand that modifications can still be made to the technical solutions recited in various embodiments described above, or equivalent substitutions can still be made to a part of technical features thereof, and these modifications or substitutions will not make the essence of the corresponding technical solutions depart from the spirit and scope of the claims.

### INDUSTRIAL APPLICABILITY

The method and device for displaying panoramic videos provided by the present application load the panoramic video from the server through the Html5 video tag, and use the 3D engine of the browser to complete playing, are no longer limited to a Flash animation manner and do not need to install a third-party plug-in while viewing the panoramic video in the webpage through the browser, so that the panoramic video can be applied in the internet video more widely, thus providing expedience for the internet users to view the panoramic videos.

What is claimed is:

1. A method for displaying panoramic videos, characterized in that, comprising:
loading a panoramic video from a server through an Html5 video tag in a play page;
mapping the panoramic video to the inner surface of a sphere model in a scene as a texture image of the sphere model, wherein the scene is created by an 3D engine, and further comprises a camera object disposed inside the sphere model; and
displaying a video image of the inner surface of the sphere model shot by the camera object under the current viewing angle in the play page.

2. The method according to claim 1, characterized in that, the method further comprises:
detecting a control operation of adjusting the viewing angle; and
displaying a video image shot by the camera object under the adjusted viewing angle.

3. The method according to claim 1, characterized in that, when a cross-origin problem exists between the panoramic video and the play page, the loading the panoramic video from the server through the Html5 video tag in the play page comprises:
requesting the panoramic video from the server, the cross-origin attribute of the video tag being set as anonymous; and
receiving the panoramic video returned by the server, wherein an http response header of the panoramic video comprises declaration information.

4. The method according to claim 3, characterized in that, the declaration information comprises the origin information of the play page, or the declaration information is a wildcard that represents to allow requesting data from any origin.

5. The method according to claim 1, characterized in that, the viewing angle of the camera object is set as a fish-eye lens viewing angle.

6. The method according to claim 5, characterized in that, the fish-eye lens viewing angle ranges from 180 degrees to 220 degrees.

7. The method according to claim 1, characterized in that, the panoramic video is a live video shot by a panoramic pick-up device.

8. A device for displaying panoramic videos, characterized in that, comprising:
a video loading module configured to load a panoramic video from a server through an Html5 video tag in a play page;
an image mapping module configured to map the panoramic video to the inner surface of a sphere model in a scene as a texture image of the sphere model, wherein the scene is created by an 3D engine, and further comprises a camera object disposed inside the sphere model; and
a video display module configured to display a video image of the inner surface of the sphere model shot by the camera object under the current viewing angle in the play page.

9. The device according to claim 8, characterized in that, the device further comprises:
an operation detection module configured to detect a control operation of adjusting the viewing angle; and
a viewing angle adjustment module configured to display a video image shot by the camera object under the adjusted viewing angle.

10. The device according to claim 8, characterized in that, the video loading module comprises:
a request submodule configured to request the panoramic video from the server, the cross-origin attribute of the video tag being set as anonymous; and
a receiving submodule receiving submodule configured to receive the panoramic video returned by the server, wherein an http response header of the panoramic video declaration information.

11. A device for displaying panoramic videos, characterized in that, comprising:
a processor; and
a memory for storing instructions executable by the processor;
wherein the processor is configured to:
load a panoramic video from a server through an Html5 video tag in a play page;
map the panoramic video to the inner surface of a sphere model in a scene as a texture image of the sphere model, wherein the scene is created by an 3D engine, and further comprises a camera object disposed inside the sphere model; and
display a video image of the inner surface of the sphere model shot by the camera object under the current viewing angle in the play page.
